(19) United States
(12) Patent Application Publication
(10) Pub. No.: US 2026/0017625 A1
(43) Pub. Date: Jan. 15, 2026

(54) COMPUTER-IMPLEMENTED METHOD OF VERIFYING USER CREDENTIALS

(71) Applicant: Dock Labs AG, Zug (CH)

(72) Inventor: Lovesh HARCHANDANI, Zug (CH)

(73) Assignee: Dock Labs AG, Zug (CH)

(21) Appl. No.: 19/269,764

(22) Filed: Jul. 15, 2025

(30) Foreign Application Priority Data
Jul. 15, 2024 (GB) 2410261.8

(51) Int. Cl. G06Q 20/06; G06Q 20/38; G06Q 20/40

(52) U.S. Cl. CPC G06Q 20/06; G06Q 20/3829; G06Q 20/4014

(57) ABSTRACT

Disclosed is a computer-implemented method of verifying credentials of a user (102) comprising receiving a verifiable presentation from the user, wherein the verifiable presentation comprises two parts; examining a first part of the verifiable presentation to identify one or more attributes of the user included in the first part; sending a second part of the verifiable presentation to a third party (106) for inspection, wherein the second part comprises a randomized message authentication code and does not contain any attributes of the user; verifying the randomized message authentication code by the third party using a secret key; and verifying the credentials of the user based on the outcome of the inspection of the second part by the third party.

### CROSS-REFERENCE TO RELATED APPLICATIONS

This application claims priority to and the benefits of United Kingdom Application No. GB2410261.8 filed on Jul. 15, 2024, the content of which is incorporated in its entirety herein.

### TECHNICAL FIELD

The present disclosure relates to computer-implemented methods of verifying user credentials.

### BACKGROUND

In the digital world, users rely on their credentials to prove their identity based on attributes, such as age, address, nationality, education, or professional licenses thereof. In this regard, traditional verification techniques are used that involve disclosing sensitive data of a user to a verifier which typically issues some sort of images of hardcopy credentials, such as passports and/or driver's licenses. However, in a later verification process, the sensitive data of the user may be leaked and subjected to misappropriation. Typically, the traditional verification techniques often involve a lot of manual effort, which can be time-consuming and error prone. Moreover, the traditional verification techniques can be expensive. Furthermore, the traditional verification techniques may only cover certain types of credentials or certain countries, which can limit their usefulness.

A verifiable credential is a digital, cryptographically secured version of both paper and digital credentials that the users can present to organizations that need them for verification. The verifiable credential issuers typically receive payment when the credential is used (such as a royalty fee) making the average revenue per credential (ARPC) limited. This is because one of the objectives of the verifiable credentials is to allow the user to control their data without the issuer dictating how and where the data can be used. In such a case, the verifier sharing the user's data with the issuer and asking if it's valid is not acceptable as it harms the user's privacy.

Previous attempts to address this challenge have involved periodic credential revocation and reissuance, coupled with charging the user during the process. However, this solution imposes additional burdens on the issuers and fails to directly charge the verifier, potentially leading to cost subsidization by the users or issuers. There exist some methods that involve locking the revocation database and charging for access to the status of the credentials. However, such methods allow the verifiers to learn the status of all the users by paying only for one, potentially leading to misuse of sensitive information. Moreover, such a method only applied to revocable credentials and entails computational overheads. Furthermore, the verifier still learns that the credential was certainly issued at some point which can be sufficient assurance in low value use cases and it might not pay for the revocation check. The aforementioned limitations highlight the need for a solution that effectively addresses verification of the verifiable credentials while strictly safeguarding the user privacy and enhancing the performance of such methods.

Therefore, in light of the foregoing discussion, there exists a need to overcome the aforementioned drawbacks.

### SUMMARY

The aim of the present disclosure is to provide a computer-implemented method to verify credentials of a user using a certificate issued by an issuer. The aim of the present disclosure is achieved by a computer-implemented method of verifying credential of the user as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWING

FIG. 1, is an illustration of a block diagram depicting steps of verifying the credentials of a user, in accordance with an embodiment of the present disclosure; and

FIG. 2 is an illustration of a flowchart depicting steps of a computer-implemented method to verify a credential of the user, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a method of verifying the credentials of a user comprising:
receiving a verifiable presentation from the user, wherein the verifiable presentation comprises two parts;
examining a first part of the verifiable presentation to identify one or more attributes of the user included in the first part;
sending a second part of the verifiable presentation to a third party for inspection, wherein the second part comprises a randomized message authentication code and does not contain any attributes of the user;
verifying the randomized message authentication code by the third party using a secret key; and
verifying the credentials of the user based on the outcome of the inspection of the second part by the third party.

The aforementioned computer-implemented method enables efficient and secure verification of the credentials of the user while minimizing the risk of unauthorized access to sensitive information. The method comprises receiving the verifiable presentation having two parts to ensure that sensitive user attributes are kept separate from the authentication process. Moreover, the method comprises sending only the second part, containing the randomized message authentication code, to the third party for inspection for safeguarding privacy of the user. Moreover, the division of the presentation into two parts allows for streamlined processing and reducing computational complexity. The use of the secret key to decode or verify the randomized code ensures that only authorized parties can verify the credentials, thereby adding an additional layer of security.

The term “credentials” as used herein refers to pieces of information or attributes that attest and verify an identity or qualifications of an individual (also referred to as the user). Optionally, the credentials could include any personal information of the user. Examples of the credentials include but are not limited to name, age, address, contact number, nationality, passport details, work status, qualifications, or any other relevant data that proves the identity or eligibility of the user. The term “user” as used herein refers to an individual or entity that possesses or presents the credentials for the verification. The term “attributes” as used herein refers to individual pieces of information or characteristics associated with the user. The one or more attributes provide particular details about the user's identity, the qualifications, or permissions. Herein, the term “verifying” refers to a process of confirming the authenticity, accuracy, or validity of the credentials of the user. Typically, the verification involves verifying the cryptographic signature on the claims made in the credential to determine whether the presented credentials are legitimate and trustworthy. Beneficially, the verification is performed to establish confidence in the identity or qualifications of the user based on the information provided in the verifiable presentation.

Optionally, the user could include individuals applying for access to services, platforms, or benefits, as well as entities such as businesses or organizations seeking validation of the qualifications or authorizations thereof.

The term “verifiable presentation” as used herein refers to a structured format or representation of the credentials of the user, typically in a digital or an electronic form. Herein, the term “parts” refers to distinct segments or components of the verifiable presentation that can be separated and processed separately. Each part serves a specific purpose or contains specific information. The parts can be processed and examined separately.

It will be appreciated that the step of receiving, from the user, the verifiable presentation enhances the privacy and security of the method by compartmentalizing the user's information.

Optionally, the steps of receiving the verifiable presentation from the user is performed further to a request for the verifiable presentation being sent by a verifier.

Herein, the term “issuer” as used herein refers to an entity or organization responsible for generating and issuing credential certificates to the users. Examples of the issuer include but are not limited to government agencies, financial institutions, educational institutions, and identity verification services. For example, a bank may issue credential certificates to the customers thereof to verify their identity for online banking services, while the educational institution may issue the credential certificates to the students upon completion of a degree program. Optionally, the user gets the credentials certificate from the issuer in the usual manner. Typically, to verify the credentials with the verifier, the user creates the verifiable presentation which is shared with the verifier.

The term “first part of the verifiable presentation” refers to a distinct section or component of the digital or electronic representation of the user's credentials. Typically, the first part comprises specific information or attributes related to the user's identity, qualifications, or permissions. For example, the first part includes personal information such as name, date of birth, and address of the user. In another example, the first part includes professional qualifications or certifications, such as degrees earned, or licenses held. In another example, the first part includes access permissions or privileges, indicating the user's authorization for certain actions or access to specific resources. In another example, the first part includes biometric data, such as fingerprints or facial recognition profiles. In other words, the first part could be checked by the verifier itself. Moreover, the first part includes any selectively disclosed one or more attributes, range proofs or any predicates that the user is proving on the credential attributes.

In this regard, the first part of the verifiable presentation is examined to identify the one or more attributes of the user by parsing and analyzing the content of the first part. The step of examining involves extracting relevant information from the verifiable presentation and matching the relevant information against predefined criteria or standards and doing cryptographic operations on them. For example, if the first part includes a field labelled “Name”, the examination process would involve retrieving the value associated with the field (e.g., “XYZ”) and identifying it as the one or more attributes of the user's identity. In some cases, such as for Know Your Business (KYB) credentials, financial details such as business registration documents, tax identification numbers, and financial statements may be included in the first part.

The term “second part of the verifiable presentation” as used herein refers to a distinct portion of the presentation that contains specific information, the randomized message authentication code, for inspection by a third party. For example, in the verifiable presentation for a Know Your Customer (KYC) process, the second part could contain cryptographic data that verifies the authenticity of the credential without revealing the personal details of the user. In other words, the second part doesn't need to contain any of the one or more attributes of the credential or any predicates but only a short tag that the issuer or a designated party can verify. The term “third party” as used herein refers to an external entity that is entrusted with inspecting the second part of the verifiable presentation to verify its authenticity.

The term “randomized message authentication code” as used herein refers to a cryptographic technique that is used to authenticate the integrity and origin of a message. The randomized message authentication code involves generating a unique code based on the contents of the message and a secret key.

In this regard, the verifier, upon receiving the presentation, sends the second part, the tag, to the issuer or the designated party for verification. If the verifier receives an affirmative response from the issuer, then the verifier knows that the first part is also valid else it cannot confirm that. The second part, the tag, could however be accompanied by other information from the credentials assuming that the user and verifier agree. In an implementation, the method enables the issuer to seek information such as if the credential is recent enough. The technical effect of the step of sending is to allow an independent third party to verify the authenticity of the credential without accessing any user attributes, thereby preserving user privacy and ensuring the integrity of the method.

Optionally, the second part further comprises a predicate on the issuance date of one or more attributes of the user to be verified. The term “predicate” as used herein refers to a condition or requirement related to one or more attributes of the user to be verified. For example, the predicate could specify that the credential is valid only if it was issued within the last six months. The technical effect of including the predicate is to add an additional layer of the verification criteria based on temporal or other attribute-related conditions, enhancing the reliability of the credential verification method.

Optionally, the verifiable presentation is based on a credential certificate generated by an issuer for the user. The term “credential certificate” as used herein refers to a digital document issued by an authority, typically referred to as the issuer, that attests to the authenticity or qualification (or any other claim) of an individual or entity. The credential certificate may include verified information about the user, such as identity details, qualifications, or permissions. For example, in the context of Know Your Customer (KYC) processes, the credential certificate may include the personal identification information, address details, and other relevant data of the user.

The technical effect of the credential certificate generated by the issuer is to ensure the integrity and authenticity of the credential information, as it originates from a reliable source. Moreover, the method provides a standardized format for presenting credentials, facilitating interoperability and compatibility across different verification systems and platforms.

Optionally, the third party is the issuer, or a verification entity that can be designated by the issuer. It will be appreciated that the method allows the issuer to get paid when its issued credentials are used without harming the user's privacy. In such a case, the issuer does not learn which of its issued credentials he is getting paid for and which verifier he is engaging with. The technical problem being solved here is making the signatures (in the verifiable credential) verifiable only by selected parties rather than by everyone. The term “verification entity” as used herein refers to an authorized party responsible for confirming the validity and authenticity of presented credentials. The verification entity may be designated by the issuer of the credential or maybe the issuer itself. The role of the verification entity is to inspect the verifiable presentation, perform necessary checks, and verify the information contained within them against trusted sources or databases.

The method enhances security and reliability in credential verification processes by allowing the issuer or its designated verification entity to perform the inspection. Additionally, the method enables the issuers to maintain control over the verification process and ensures that only authorized entities have access to sensitive credential information. Furthermore, the method enables verification of whether some information is attested (namely, signed) by the issuer.

The term “secret key” as used herein refers to a piece of confidential information that is used in cryptographic algorithms to encrypt and decrypt data, namely, sign and verify, respectively. In other words, the secret key is used to sign and verify the data. The secret key is known only to authorized parties involved in the communication process and is kept securely to prevent unauthorized access. In this regard, the randomized message authentication code is generated based on certain cryptographic algorithms. Then, the second part of the verifiable presentation, which contains the randomized message authentication code, is sent to the third party for inspection. The third party holds the secret key necessary for verifying the randomized message authentication code. Upon receiving the second part, the third party utilizes the secret key to verify the randomized message authentication code. The randomized message authentication code is used to ascertain the authenticity of the credentials contained in the first part. In such a case, the verifier could seek confirmation on the randomized message authentication code from the issuer. Herein, the outcome of the inspection refers to the result obtained after the third party examines the second part of the verifiable presentation.

Optionally, the verifiable presentation contains a non-revocation proof for one or more attributes of the user. The term “non-revocation proof” as used herein refers to a cryptographic mechanism used to demonstrate that a credential issued to a user has not been revoked by the issuer. The non-revocation proof ensures that the user's credential remains valid over time, even after it has been issued. In an example, the non-revocation proof is when a professional certification issued by a licensing authority remains valid unless explicitly revoked due to misconduct or expiration. In this regard, the non-revocation proof is present in the verifiable presentation.

In this regard, in order to generate the non-revocation proof, the user uses the witness and performs the further steps. The verifier then receives the verifiable presentation and sends the second part to the issuer or the designated party for verification. Upon receiving the second part, the issuer verifies its authenticity, which indirectly confirms the validity of the first part of the verifiable presentation. The technical effect of deploying the verifiable presentation for generating the non-revocation proof is to allow the verification of the credential without revealing sensitive information to parties other than the issuer or designated verifier, thus preserving the privacy of the user. In addition, the method allows a selective verification of the signature used in the non-revocation proof. Optionally, the method allows the selective signature verification to be accompanied by other checks on one or more attributes. Optionally, the signer can delegate verification to a centralized entity by using pairings. Being able to delegate this selective verification to a blockchain is another capability that makes the verification “unstoppable”, i.e., the verification would work even when the issuer or the designated parties go out of business. This is achieved through linear secret sharing. In contrast, the method allows the credential verification to be payable as well and thus works for the non-revocable credentials as well. Advantageously, the computational cost of the verification is significantly less than existing implementations.

Optionally, bilinear map accumulators are used to prove set membership or non-membership in zero knowledge. The term “bilinear map accumulators” as used herein refers to cryptographic tools that allow for the aggregation of multiple values into a single accumulator, while still retaining the ability to prove the inclusion or exclusion of specific values without revealing any additional information. Notably, the bilinear map accumulators rely on bilinear maps. Typically, the bilinear maps are mathematical functions defined on pairs of groups. Optionally, the construction of membership proof for doing non-membership may be employed, and thus making the membership or non-membership proof more efficient.

In this regard, the proof involves using the accumulated value along with other cryptographic operations to demonstrate knowledge of a witness that corresponds to the desired value. Conversely, to prove that a value is not part of the set, the users construct a similar proof without possessing knowledge of any valid witnesses for that value. This process allows users to demonstrate the absence of the value in the set without revealing any specific information about the set's contents. It will be appreciated that the use of the bilinear map accumulators for set membership or the non-membership proofs enhances the privacy and security of cryptographic protocols. The aforementioned zero-knowledge proofs are not publicly verifiable but only by certain parties that the issuer designates, namely a designated party. In this regard, the designated party may be a single entity or a set of independent entities acting as a decentralized system that can exist as a blockchain or on a blockchain. Beneficially, the decentralized system has the potential to revolutionize traditional organizational structures by enabling decentralized decision-making, transparency, and autonomy.

The method extends the protocol for anonymous credentials and the non-revocation proofs keeping the aforementioned guarantees. The idea is for the issuer to put (or remove) the one or more attributes in the bilinear map accumulator and give a “witness” to the user. This “witness” is a weak-BB signature on the one or more attribute which can be updated as the bilinear map accumulator changes. Optionally, the method adapts the algebraic MAC to make the “witness” verifiable only when the secret key is known. The non-revocation proof protocol involves the user randomizing the witness (algebraic MAC) and using the Schnorr protocol to prove the equality of the accumulator member/non-member with the credential attribute. Similar to above, the method detaches the randomized MAC and sends only that to the issuer to verify. The issuer could also provide a proof of validity or invalidity of the algebraic MAC to the verifier by engaging in a proof of equality or proof of inequality of discrete logarithms protocol.

Following are the protocols for the membership and the non-membership proof for the non-revocation using an additive notation.
P=EC group generator, part of public params
Q=Accumulator manager public key
alpha=Accumulator manager secret key
y=Accumulator member
V=Accumulator value
C=membership witness
(C, d)=non-membership witness

Membership witness is C*(y+alpha)=V.

When the user gets the bilinear map accumulator witness C from the bilinear map accumulator manager, the bilinear map accumulator manager should also prove that alpha is the same as in the public key. Thus, proves knowledge of the alpha in C*alpha=V−C*y and Q=P*alpha.

Moreover, when proving the knowledge of membership witness:
1. The user chooses random elements I from Z_p.
2. The user randomizes the witness C as B_0=C*I.
3. The user compute D=V*I−B_0*y. Note that D=C*alpha*I (since D=V*|−C*I*y=I*(V−C*y)=I*C*alpha).
4. The user will send B_0 and D to the verifier.
5. The user builds proof pi that proves knowledge of I and y in D.
6. The verifier checks if D equals B_0*alpha and then the verifier proof pi

Following is the mapping of symbols from the Improved Algebraic MAC paper to the above
C_tilde_m->V

$$r -> y$$

$$C -> D$$

Non-membership witness is C*(y+alpha)+P*d=V.

When the user gets the accumulator witness (C, d) from the accumulator manager, the manager proves the knowledge of alpha in C*alpha=V−C*y−P*d and Q=P*alpha. The user already knows V, C,d, and y.

The public parameters contain an elliptic curve generator Q which is generated randomly such that its discrete log wrt P is not known.

Moreover, when proving the knowledge of the non-membership witness:
1. The user chooses a random element I from Z_p.
2. The user randomizes the witness (C, d) as (B_0, B_1) where B_0=C*| and J=Q*d*I.
3. The user computes D=V*I−B_0*y−P*d*I. Note that D=C*alpha*I (since D=V*I−C*I*y−P*d*I=I*(V−C*y−P*d)=I*C*alpha).
4. The user will send B_0, J, and D to the verifier.
5. The user builds proof pi that proves knowledge of y, I and Id in D=V*|−B_0*y−P*d*I and J=Q*d*I and also that d*I is the same in both equations (Schnorr protocol).
6. The verifier checks
   a. D equals B_0*alpha
   b. J is not 0 to ensure that d not equals 0
   c. proof pi.

Optionally, the verifiable presentation is deployed for making private payments between various entities. The term “private payments” as used herein refers to financial transactions conducted between various entities in a manner that ensures privacy and confidentiality. Herein, the entities could be the users, businesses, financial institutions, payment processors, government agencies, and so forth. The private payments aim to protect sensitive information such as the identities of the transacting parties, transaction amounts, and other transaction details. Optionally, the private payment includes cryptocurrency transactions. The technical effect of deploying the verifiable presentation for private payments involves leveraging cryptographic techniques to ensure the confidentiality of payment-related information. Moreover, the verifiable presentation allows the entities to engage in financial transactions with confidence while minimizing the risk of privacy breaches or unauthorized access to transaction data.

In an implementation, the method could be used in any scenario where the verifiable credentials are used and the issuer expects a recurring payment for the services thereof. In an implementation, the method could be used by background check companies, especially for professionals working in certain industries such as the healthcare industry.

Optionally, the signer can delegate the verification job to a single entity or a decentralized system (blockchain). The check is done in KVAC (Keyed-Verification Anonymous Credentials) style credentials and revocation is done by the issuers in DLOG (Discrete Logarithm) check, i.e., for a given pair (A, B), it is checked if B=A*k, where k is the secret key of issuer and pair (A, B) is part of the proof given to the verifier. It may be appreciated that the DLOG check may also be performed on KVAC in non-revocable credentials. The method enables the blockchain or the signer's delegated party to do the aforementioned check without learning k (so it can't sign new credentials).

It may be appreciated that by delegating the verification job to the single entity, multiple entities, or the decentralized system like blockchain, provides different levels of efficiency, reliability, and security. For example, when the verification job is delegated to a single entity, the verification process is streamlined (easier management and coordination and reduced overhead costs) and thus the verification time is quicker as compared to the verification time taken by multiple entities and decentralized systems. However, in case of multiple entities, the verification process is more reliable due to increased fault tolerance through consensus among entities and reduced risk of collusion and single-point failure.

Optionally, when a signer delegates the verification job to a single party, the check is done using pairings. The signer gives points P and Q (=P*1/k), where both P and Q are in group G2 and then the delegated party verifies this using type-3 pairing check e(B, Q)=e(A, P) as (A, B) are in group G1. The delegated party learns (A, B) but this does not reveal anything about the holder. This can also be done by creating P, Q=(P*k) and then making the check as e(A, Q)=e(B, P).

Optionally, the signer can delegate the verification job to any number of delegated parties and for each delegated party, a different pair of (P, Q) is selected. Here P can be generated by hashing the delegated party id string to a G2 element.

Optionally, the signer can delegate the verification job to a decentralized system, eg., a blockchain, the decentralized system should be able to answer if B=A*k without knowing k but knowing B and A is fine.

Notably, the decentralized system participants may not be the blockchain validators, it could be any set of entities the issuer chooses to delegate the check to. Moreover, the issuer (signer) may decide to share the secret key among the decentralized system participants in such a way that computation on the shares can be done by each participant independently and a threshold number of participants can then combine their computations to get a joint result. In an example, the decentralized system is an untrusted checker (UC), and the issuer distributes its signing key k as n shares (encrypted for corresponding participants) k_1, k_2, . . . k_n, among n participants UC_1, UC_2, . . . . UC_n, such that any threshold (t) of the UC_1, UC_2, . . . . UC_n can reconstruct k. Examples of such sharing protocol includes, but is not limited to, Shamir secret sharing, Feldman Secret Sharing (a verifiable variant of Shamir secret sharing). In an implementation, the sharing protocol used is the Feldman Secret Sharing. The Feldman Secret Sharing protocol ensures that each UC_i can verify that the issuer did the sharing correctly. In this regard, when requested by the verifier to check if B=A*k, given (A, B), any t participants of UC can jointly compute A*k by first computing intermediate result R_i=A*k_i and combining all R_i s using Lagrange coefficients to compute R=\sum_i{I_i*R_i}=\sum_i{I_i*A*k_i}=A*\sum_i{\_i*k_i}=A*k where I_i is the i_th Lagrange coefficient. Now it can be checked (on the blockchain as well) if R=B.

Notably, if k of the n participants of UC goes rogue or are compromised, they can recover the secret key k. However, such recovery may be mitigated by increasing the computation and bandwidth of the protocol. In this regard, rather than distributing its signing key k shares k_1, k_2, . . . k_n, the issuer distributes points (encrypted for corresponding participants) P*k1, P*k_2, . . . . P*k_n among n participants UC_1, UC_2, . . . . UC_n such that any threshold (t) of the UC_1, UC_2, . . . . UC_n can reconstruct P*k (k_1, k_2, . . . k_n are shares of k. When requested by the verifier to check if B=A*k, given (A, B), any t participants of UC can jointly compute the pairing e(A, P*k) by first computing intermediate result R_i=e(A, P*k_i) and combining all R_i s using Lagrange coefficients to compute R=\sum_i{I_i*R_i}=\sum_i{I_i*e(A, P*k_i)}=A*\sum_i{l_i*e(A, P*k_i)}=A*e(A, P*k), where I_i is the i_th Lagrange coefficient. Now it can be checked (on the blockchain as well) if R=e(B, P).

Moreover, it may be appreciated that any untrusted checker UC_i may respond with gibberish and thus make the result unreliable. This is because the response R_i is not verifiable, i.e., it cannot be verified whether UC_i performed a job as desired. Here, it is assumed that there already exists a (binding not hiding) commitment Cm to the secret share on the blockchain, i.e., Cm=e(J, P*k_i), where J is a public element. Such commitment might be posted by UC_i or by the signer during secret share distribution, but it must be done only once. When UC_i provides its share of the joint computation (DLOG check), i.e., e(A, P*k_i), it proves that P*k_i is the same in both e(J, P*k_i) and e(A, P*k_i) using Sigma protocol (Schnorr protocol for pairings). Similar proof would apply to the non-pairing-based protocol as well.

As mentioned above, the signer shares his secret key k as P*k_i (k_i being shares of k) but this isn't ideal as P*k_i is a binding commitment to k_i but not hiding. This can be improved by changing P*k_i to P*k_i+T*r_i where r_i are shares of 0 (\sum (l_i*r_i)=0 where I_i are Lagrange coefficients). The aforementioned protocols are used for verifying the secret share (using 2 polynomials, one for sharing k and one for sharing r), joint computation, and proving the computation can be modified accordingly.

The new share is s_i=P*k_i+T*r_i and share verification works by the signer committing to coefficients of 2 polynomials, polynomial F for sharing k and polynomial G for sharing r. F(x)=a_0+a_1*x+a_2*x\hat{ }2+ . . . +a_{n−1}*x\hat{ }n−1 where F(0)=k, F(i)=k_i and G (x)=b_0+b_1*x+b_2*x\hat{ }2+ . . . +b_{n−1}*x\hat{ }n−1 where G (0)=r=0, G (i)=r_i. Now, the signer shares commitments to coefficients of both polynomials as C=g, g*a_0, g*a_1, . . . , g*a_n−1 and D=g, g*b*_0, g*b*_1, . . . , g*b_n−1. On receiving the share s_i, each participant checks e(g, s_i)=e(\sum{\prod_j {C_j, i\hat{ }j}}, P)+e(\sum{\prod_j {D_j, i\hat{ }j}}, T). This works because e(\sum{\prod_j {C_j, i\hat{ }j}}, P)+e(\sum{\prod_j {D_j, i\hat{ }j}}, T)=e(g+g*a_0*i+g*a_1*i\hat{ }2+ . . . +g*{a_n−1}*{i\hat{ }n−1}, P)+e(g+g*b_0*i+g*b_1*i\hat{ }2+ . . . +g*{b_n−1}*{i\hat{ }n−1}, T)=e(g*(1+a_0*i+a_1*i\hat{ }2+ . . . + {a_n−1}*{i\hat{ }n−1}), P)+e(g*(1+b_0*i+b_1**\hat{ }2+ . . . +{b_n−1} {i\hat{ }n−1}), T)=e(g*F(i), P)+e(g*G(i), T)=e(g, P*F(i))+e(g, T*G(i))=e(g, P*F(i)+T*G(i))=e(g, s_i).

When requested by the verifier to check if B=A*k, given (A, B), any t participants of UC can jointly compute the pairing e(A, P*k) by first computing intermediate result R_i=e(A, P*k_i+T*r_i) and combining all R_i's using Lagrange coefficients to compute R=\sum_i{L_i*R_i}=\sum_i{I_i*e(A, P*k_i+T*r_i)}=e(A, \sum_i{I_i*P*k_i})+e(A, \sum_i{I_i*T*r_i})=e(A, P*k)+e(A, T*r)=e(A, P*k), since r=0, where I_i is the ith Lagrange coefficient. Now it can be checked (on the blockchain as well) if R=e(B, P). To prove that R_i is properly created, UC_i needs to prove using the similar protocol as above but modify Cm, such that rather than Cm=e(J, P*k_i), Cm=e(J, P*k_i+T*r_i) is used.

It may be appreciated that sharing protocol may not be restricted to Shamir or Feldman secret sharing, other schemes supporting a dynamic group and proactive refresh like CHURP (https://eprint.iacr.org/2019/017) may be used so that signers can change the delegates. The secret-sharing scheme should however preferably be linear.

The present disclosure also relates to the computer-implemented method of verifying credentials of the user as described above. Various embodiments and variants disclosed above, with respect to the aforementioned method of verifying credentials of the user, apply mutatis mutandis to the computer-implemented method of verifying credentials of the user.

### DETAILED DESCRIPTION OF THE DRAWINGS

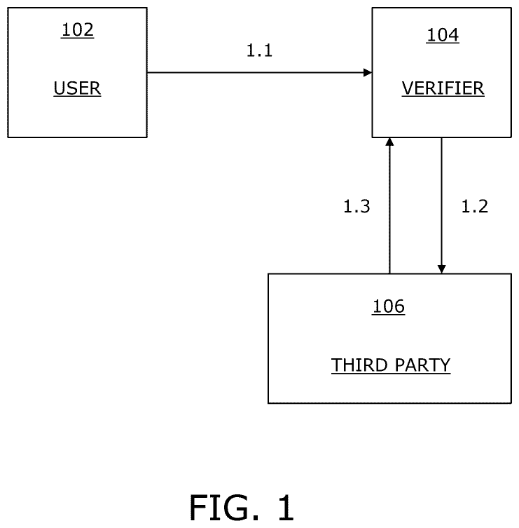

Referring to FIG. 1, illustrated is a block diagram depicting steps of verifying credentials of a user 102, in accordance with an embodiment of the present disclosure. The user 102 is an entity whose credentials are required to be verified. There is also shown a verifier 104 which is another entity requesting the verification of the user's credentials. Moreover, there is shown a third party 106 which is yet another entity responsible for validating a randomized message authentication code associated with the user's credentials. Herein, the third party 106 could be the issuer, a designated verification entity.

At step 1.1, the user 102 provides a verifiable presentation to the verifier 104. The verifiable presentation comprises two parts, the first part includes the one or more attributes of the user 102 for the verification task. The second part comprises a randomized message authentication code and preferably does not contain any attributes of the user 102. The verifier 104 examines the first part of the presentation to extract one or more attributes of the user 102. At step 1.2, the verifier 104 sends the second part to the third party 106 for inspection. The third party 106 decodes or verifies the randomized message authentication code using a known secret key and potentially performs additional checks based on stored rules. At step 1.3, the third party 106 sends the verification outcome back to the verifier 104.

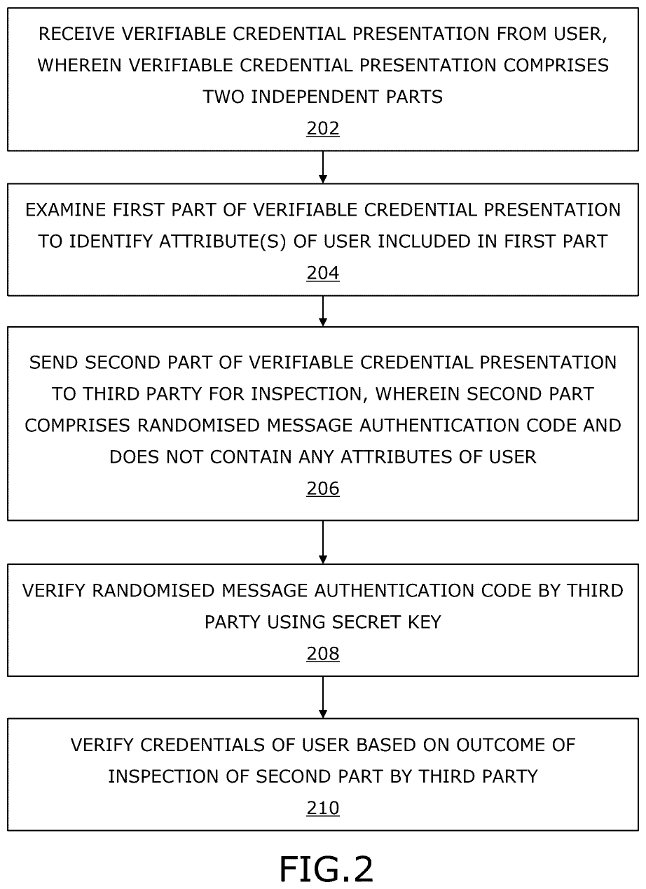

Referring to FIG. 2, illustrated is an illustration of a flowchart depicting steps of a computer-implemented method to verify credential of the user, in accordance with an embodiment of the present disclosure. At step 202, a verifiable presentation is received from the user, wherein the verifiable presentation comprises two parts. At step 204, a first part of the verifiable presentation is examined to identify one or more attributes of the user included in the first part. At step 206, a second part of the verifiable presentation is sent to a third party for inspection, wherein the second part comprises a randomized message authentication code and does not contain any attributes of the user. At step 208, the randomized message authentication code is decoded or verified by the third party using a secret key. At step 210, the credentials of the user are verified based on the outcome of the inspection of the second part by the third party.

Moreover, the separation allows for parallel processing, with the verifier focusing on essential attributes and the third party verifying the randomized message authentication code independently. Additionally, the method avoids the need for managing and potentially decrypting large revocation databases, making the method suitable for large-scale deployments.

The aforementioned steps are only illustrative and other alternatives can also be provided where one or more steps are added, one or more steps are removed, or one or more steps are provided in a different sequence without departing from the scope of the claims herein.

What is claimed is:

1. A computer-implemented method of verifying credentials of a user (102) comprising:
receiving a verifiable presentation from the user, wherein the verifiable presentation comprises two parts;
examining a first part of the verifiable presentation to identify one or more attributes of the user included in the first part;
sending a second part of the verifiable presentation to a third party (106) for inspection, wherein the second part comprises a randomized message authentication code and does not contain any attributes of the user;
verifying the randomized message authentication code by the third party using a secret key; and
verifying the credentials of the user based on the outcome of the inspection of the second part by the third party.

2. The computer-implemented method of claim 1, wherein the verifiable presentation is based on a credential certificate generated by an issuer for the user (102).

3. The computer-implemented method of claim 2, wherein the third party (106) is the issuer, or a verification entity designated by the issuer.

4. The computer-implemented method of claim 1, wherein the second part further comprises a predicate on the issuance date of the one or more attributes of the user (102) to be verified.

5. The computer-implemented method of claim 1, wherein the verifiable presentation is deployed for generating non-revocation proof for the one or more attributes of the user (102).

6. The computer-implemented method of claim 5, wherein bilinear map accumulators are used to prove set membership or non-membership in zero knowledge.

7. The computer-implemented method of claim 1, wherein the verifiable presentation is deployed for making private payments between various entities.
